(19) United States
(12) Patent Application Publication
(10) Pub. No.: US 2014/0108625 A1
(43) Pub. Date: Apr. 17, 2014

(54) SYSTEM AND METHOD FOR CONFIGURATION POLICY EXTRACTION

(71) Applicants: Yuval Carmel, Tel Aviv (IL); Omer Barkol, Haifa (IL); Ruth Bergman, Haifa (IL); Oded Zilinsky, Yehud (IL); Ido Ish-Hurwitz, Kfar-Saba (IL); Shahar Golan, Haifa (IL); Ron Banner, Yokneam (IL)

(72) Inventors: Yuval Carmel, Tel Aviv (IL); Omer Barkol, Haifa (IL); Ruth Bergman, Haifa (IL); Oded Zilinsky, Yehud (IL); Ido Ish-Hurwitz, Kfar-Saba (IL); Shahar Golan, Haifa (IL); Ron Banner, Yokneam (IL)

(73) Assignee: HEWLETT-PACKARD DEVELOPMENT COMPANY L.P., Houston, TX (US)

(21) Appl. No.: 14/118,235

(22) PCT Filed: May 20, 2011
(86) PCT No.: PCT/US2011/037313

§ 371 Date: Nov. 17, 2013

(51) Int. Cl. H04L 12/24

(52) U.S. Cl. CPC H04L 41/0893
USPC 709/220

(57) ABSTRACT

A method for configuration policy extraction for an organization having a plurality of composite configuration items may include calculating distances in a configuration space between the composite configuration items. The method may also include clustering the composite configuration items into one or more dusters based on the calculated distances. The method may further include identifying configuration patterns in one or more of the clusters, and extracting at least one configuration policy based on the identified configuration patterns. A non-transitory computer readable medium and a system for configuration policy extraction for an organization having a plurality of composite configuration items are also disclosed.

### BACKGROUND OF THE INVENTION

Configuration management practices in large information Technology (IT) organizations are moving towards policy-driven processes, in which IT assets are managed uniformly throughout the organization.

In many organizations a configuration policy may not be specifically defined, not known, and even if known or defined, may not be relevant to the actual configuration status of its assets. Furthermore, in many organizations the status of assets may dynamically change, making it even more difficult for IT managers to monitor assets configurations, let alone decide on configuration policies for their assets.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference, to the following detailed description when read with the accompanying drawings in which:

FIG. 1 illustrates a method for configuration policy extraction according to embodiments of the present invention.

FIG. 2 illustrates a composite Configuration Items (CI) tree for an exemplary “j2ee-doman”.

FIG. 3 illustrates a set up of a multiple-assignment problem of matching between nodes in composite CIs, by solving a minimal flow problem (successive shortest path) using a bipartite graph, according to embodiments of the present invention.

FIG. 4 depicts a simple policy rule 400 that was extracted from a large database in accordance with embodiments of the present invention.

FIG. 5 illustrates a system for configuration policy extraction, in accordance with embodiments of the present invention.

FIG. 6 illustrates a configuration policy extractor device, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF EMBODIMENTS OF THE PRESENT INVENTION

IT practitioners typically have responsibility to a specific set of configuration items, and, thereby, a limited view of the overall organization, in many organizations no one actually knows how configuration items are managed throughout the organization. As often occurs in practice, there is a risk with a configuration policy management tool (and such tools are known) that such tool will not be properly used because of lack of knowledge cm the actual configuration status in the organization, and hence, the organization may not enjoy the benefits that such tool can provide.

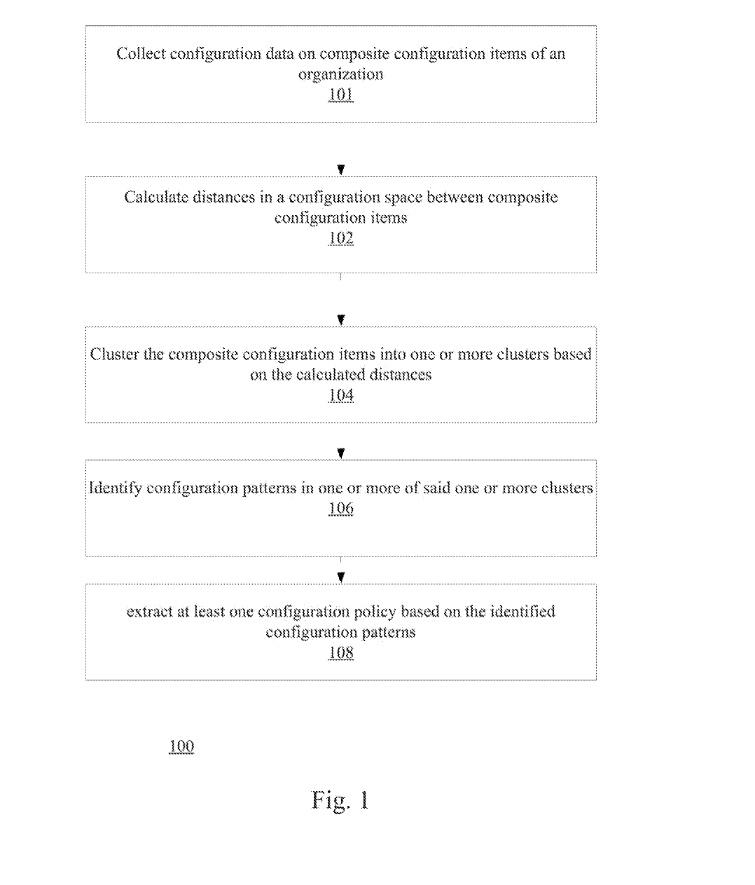

FIG. 1 illustrates a method for configuration policy extraction according to embodiments of the present invention.

In accordance with embodiments of the present invention, a method 100 for configuration policy extraction may include calculating 102 a distance in a configuration space between composite configuration items (CI) of an organization. The method may further include clustering 104 the composite configuration items into one or more clusters based on the calculated distances. Each cluster may be characterized by the distance between its composite configuration items (e.g. such distance is not greater than a maximal threshold distance). The method may also include identifying 106 configuration patterns in one or more of said one or more clusters and extracting 108 at least one configuration policy based on the identified configuration patterns. The method may further include collecting 101 configuration data on the composite CIs of the organization. “An organization” in the context of the present invention may include firms, institutions and other organizations. It may also include any establishment that has many CIs that may wish to monitor the configuration of its CIs and/or derive a configuration policy based on current CI configuration.

By “policy” is meant, in the context of the present invention, any configuration standard that may be suggested to the organization. A configuration policy may be generated manually, for example, based on projected targets and plans, or may be based, for example on processing configuration information available for that organization. A configuration policy may be typically aimed at enforcing it as a configuration standard for that organization.

The configuration data may be stored, for example, in a Configuration Management Data Base (CMDB). According to some embodiments of the present invention, configuration data may be collected manually, for example, by recording configuration data each time a change in the configuration of an existing composite CI occurs, or inputting configuration data each time a new composite CI is added. According to other embodiments of the present invention, configuration data maybe collected and stored automatically by employing a crawler application that constantly, periodically or otherwise, searches an organization network to determine the configuration status of its composite CIs.

According to embodiments of the present invention, IT practitioners may use the proposed method to analyze the configuration of CIs of the organization. This may be useful when planning acquisitions or on hoarding new clients for Managed Service Providers (MSPs).

Some basic definitions and notations are provided hereinafter fur sake of clarity. A composite configuration item (CI) is typically represented in a CMDB as a tree. An explicit composite or simple CI will be denoted by CI. Each simple CI may have a type denoted by type(CI), and a set of attribute values, attr₁(CI), . . . , attrₖ(CI)∈ Θᵢ₌₁ⁱAᵢ, where Aᵢ is a set possible values for the i-th attribute. For instance, a composite CI can he of type NT and have in the i-th attribute, which specifies, for example, an “operation system”, the value “Windows-7”. It might have different children CIs, e.g., a. CI of the type “CPU”. When one refers to CI one might consider only simple CI (with its attributes), or the entire tree, where the CI is the root of that tree. The terms simple CI and composite CI are used herein in order to differentiate the context when unclear.

A composite CI, is comprised of a tree of CIs, denoted by T(CI). A tree in this context may be a directed graph G(V,E) where V is the set of nodes and E is the set of directed edges. If (u, v) ∈ E then one may say that u is the parent of v and v is the child of u. If further (u,w) ∈ E with w≠v, one may say that w is a sibling node of v. The root node of a tree T may be denoted by root(T) and the children of a node v may be denoted by children(v). It can be said that there exists a path between v and u if (v, u) ∈ E or if there exist v₁, . . . , vₖ such that (v,v₁), (vₖ,u) ∈ E and for all 1≦i≦k−1, (vᵢ, vᵢ₊₁) ∈ E. Such a path may be denoted by v→u. Sometimes a tree may be traversed according to some order. In that case IT (v) may denote the index of v in that order of the tree T. It the context is clear one rosy neglect the T subscript. A vector may be denoted by \vec{x}=x₁, . . . , xₐ˜x.

Computing the distance in a configuration space between composite CIs may be equivalent to determining similarity between composite. CIs, Composite CIs may typically be represented in tree structures. Thus the problem of computing the distance between CIs may be represented as determining similarity between trees, which is commonly studied in the setting of tree edit distance algorithms. Tree edit algorithms have been used to solve problems in molecular biology, XML document processing and other disciplines. A definition of edit distance for labeled ordered trees that was proposed in the past allows three edit operations on nodes—“delete”, “insert”, and “relabel”. For unordered trees the problem is known to be NPhard. For ordered trees, on the other hand, polynomial algorithms exist, based on dynamic programming techniques. Several researchers have identified restrictions to this definition of edit distance. CI similarity may represent a unique set of constraints for tree-editing.

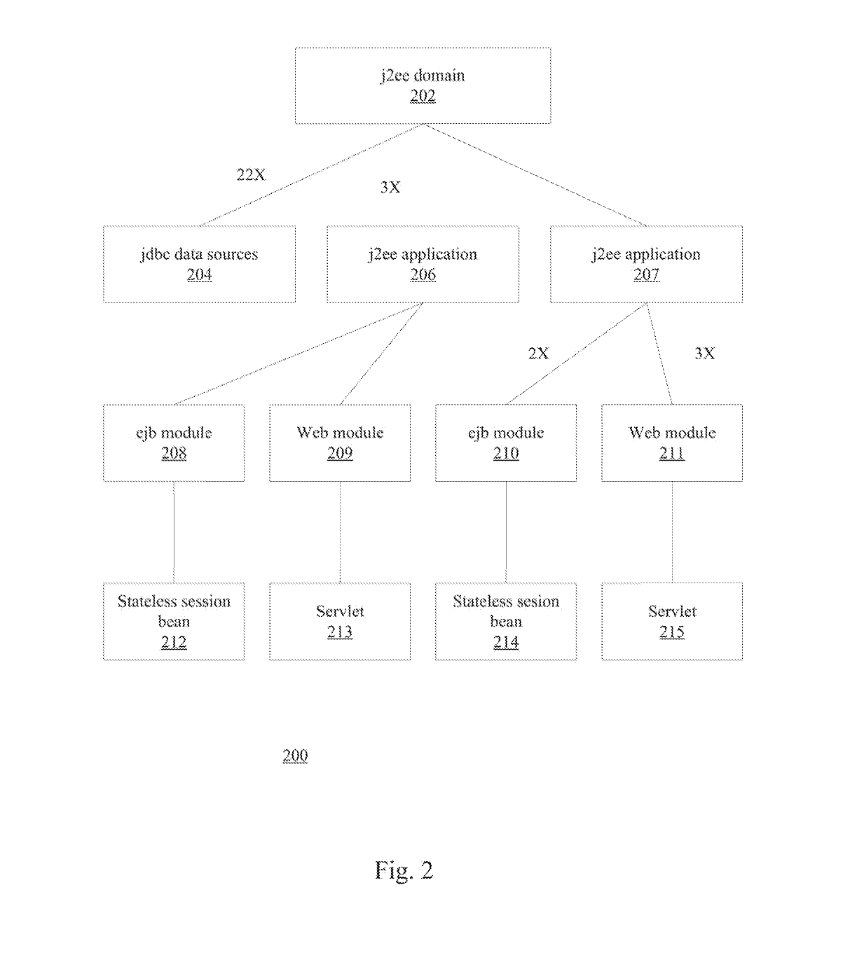

To preserve CI structure, “delete” and “insert” operations would not apply to single nodes, rather they may be applied to complete sub-trees. For example, FIG. 2 depicts a composite CI tree 200 for a) “j2ee-doman” 202. In this example “i2ee-doman” 202 is parent to jdbc data sources 204 and j2eeapplication 206, 207. Furthermore, j2eeapplication 206, 207 are parents to ejb module 208, web module 209 and ejb module 210, web module 211 (respectively). Moreover, ejb modules 208, 210 are parents to stateless session beans 212, 214 (respectively) and web modules 209, 211 are parents to servlets 213, 215 (respectively), Ejb modules 208, 210, must be the children of j2eeapplication 206, 207 (respectively). One cannot delete j2eeapplication (204, 207) and add ejbmodule as a child to j2ee-domain 202—the parent of j2eeapplication 206, 207. It is possible to change some attributes of a CI in a relabel operation, but not to change its type. Thus in order to calculate the distance between individual nodes attributes of the CIs may be compared.

As the children CIs of a CI are unordered, the match between children of two CIs is typically not one-to-one. For example, a j2eedomain may be comprised of any number of 2eeapplications. One may not want to consider two j2eedomains to be very different if one includes five j2eeapplications, while the other includes fifty. Thus, multiple children on one side may be mapped to a single child on the other side, and vice versa. On the other hand, for example, a Windows NT server with one Central Processing Unit (CPU) is very different from a Windows NT sever with four CPUs. Thus, a penalty may be considered on multiple assignments, which depends on the CI type. These constrains may be among the considerations guiding the design of a CI edit distance measure. The constraints on “delete” and “insert” operations allow one to utilize a top-down methodology for computing the edit distance similarly. On the other hand, one may not employ dynamic programming to match between child nodes, because it assumes an ordered, one-to-one match. Instead, a multiple-assignment may be defined. This assignment may be reduced to a minimum cost flow problem, which may he solved, for example, by using a successive shortest path algorithm in polynomial time. The complete tree edit distance is computed by activating this procedure recursively and has also a polynomial running time.

To self-organize a configuration, one may want to find frequent patterns of CIs. Since CIs are trees, one may need an algorithm for frequent tree mining. Such algorithms are used to search for repeating, subtree structures in an input collection of trees. These algorithms may vary in the restrictions that the repeating structure must adhere to, and in the type of trees that are searched. For mining configuration items, one may be interested in a particular tree mining scenario.

After the distances between composite CIs are calculated the composite CIs may be clustered based on the calculated distances.

Various efficient non-parametric clustering algorithms may be used. According to embodiments of the present invention, the distances between all the composite CIs are considered, including one that are subtrees within other composite CIs. So, if one may view a given set of composite CIs as a threat, the distance between every two sub-trees in that forest may be considered. A cluster of composite CIs at the root level may help determine configuration policies E.g. CI clusters of internal CIs may represent prevalent patterns of such policies.

An input set of CIs may be computed by the CI clustering algorithm, or it may be manually selected by a user.

To generate a baseline policy, one may collect statistics about each CI pattern. Then, a policy may be extracted, by adding one pattern at a time, e.g., in a greedy manner, while making sure that the policy adequately covers the input set of CIs.

For the sake of simplicity of expositions, the algorithms described herein are written as if the clustering is outputting a single largest cluster of CIs and a policy for this cluster is extracted. Trivially, the clustering can output all dusters and then a number of policies may be produced—one for each cluster, or for several clusters.

An algorithm such as the one presented herein may be considered:

| | |
|---|---|
| Algorithm: GeneratePolicy(\vec{C}I, θ, α) | (1) |
| N ← Σᵢ₌₁ⁿ\|CIᵢ\| | |
| Comment: create distance matrix | |
| Params ← Preprocess(\vec{C}I) | |
| D[1...N,1...N] ← ∞ | |
| for i ← 1 to n, j ← 1 to n | |
| do M_{D} = CITreeEdit(CIᵢ, CI, Params) | |
| update D from M_{D} | |
| Comment: cluster CIs | |
| S ← NonParametricClustering(D,θ) | |
| Comment: generate policy P | |
| G_{P} ← ComputePatternGraph(S,\vec{C}I) | |
| P ← GeneratePolicy(G_{P}\vec{C}I, α) | |
| return (P) | |

In algorithm (1) the first stage creates a distance matrix D of size N×N, where N is the number of composite CIs including internal CIs (that is, the number of sub -trees in the forest of the input CIs). This matrix is populated by repeatedly computing a distance matrix M_{D} which includes the distances between all the sub-trees of one composite CI CIᵢ and the sub-trees of another composite CI CIⱼ, D is input to the clustering stage as input. Then a policy may be computed so that for in least α fraction of the input CIs the policy holds.

The creation of CI tree-edit distance matrix D is elaborated hereinafter.

Tree-edit distance may depend on the following four cost types:

rep(C_{b}CIⱼ) which may compute the cost of replacing the simple CI CIᵢ by the simple CI Cⱼ. This computation may depend mainly on the attributes of each CI. One may assume that one gets as input the function \ddot{W} which determines the distance between two simple CIs weighing the attributes;

mult(CIᵢ) which may compute the cost of replacing one instance of a simple CI CIᵢ by more than one CI. One may assume that one gets as input the function \ddot{P} which gives a penalty to each type of simple CI if assigned with multiplicity;

del(CIᵢ) which may compute the cost of deleting the CI subtree T(CIᵢ); and

ins(CIᵢ) which may compute the cost of inserting the CI subtree T(CIᵢ).

As one can see in algorithm (1) at includes a preprocessing step to inter parameters. Explicitly, the parameters \ddot{W} and \ddot{P}, which are required for the four cost functions. For simplicity one may assume that \ddot{W} and \ddot{P} are part of the input. It may be further assumed that the time to compute these four functions is independent of the size of the subtree. In the present example, the cost for insertion and deletion is constant independent of the input value (Alternatively, the values can be pre-computed prior to the tree distance computation).

An exemplary recursive algorithm for computing the tree distance for composite CIs is presented below. In each step, two nodes (simple CI) and their children may considered. If the nodes are not of the same type, or one of them has no children, the case is more simple. In the general case, the distance between each pair of the children is recursively computed, and the distance between the nodes along with the distance between the two sets of children is then considered. The maximum of the two distances is used in the present example, but as an alternative one may use the sum.

| | |
|---|---|
| Algorithm: CITreeEdit(M_{D}, T₁, T₂, p) | (2) |
| n₁ ← \|T₁\|, n₂ ← \|T₂\| | |
| r₁ ← root(T₁), r₂ ← root(T₂) | |
| \vec{C}₁ ← children(r₁), \vec{C}₂ ← children(r₂) | |
| if rep((r1,r2)) =inf, | |
| then M_{D}(I(r₁), I(r₂)) = inf return | |
| if n₁=0 or n₂=0 | |
| then M_{D}(I(r₁),I(r₂)) = max(rep(r₁, r₂)), | |
| Σᵢ₌₁ⁿ¹del(c₁[i]) + Σⱼ₌₁ⁿ²ins(c₂[j]), return | |
| for i ← 1to n₁, j ← 1 to n₂ | |
| do CITreeEdit(M_{D,} c₁[i], c₂[j], p) | |
| M_{D}(I(r₁),I(r₂)) = max(rep(r₁, r₂)), | |
| MinCost(M_{D,} \vec{c}₁, \vec{c}₂, p) | |
| return | |

The function MinCost appears to be the heart of the edit distance algorithm. It computes an assignment between the two sets of children (Composite CIs) of current nodes, taking into account the constraints of this problem.

The “edit distance” of child CIs between two CIs embodies some unique constraints of this problem, as discussed hereinabove. Basically, given, two sets of child nodes in a tree, one may want to match each node in one set to a node, or a sub-set of nodes, in the other set, so that the cost would be minimal. The use a cost function is aimed to allowing, in some cases, matching one-to-many with low cost, when the multiplicity of the type of the node is of lesser significance (e.g. the number of configured IP addresses for a computer). In other cases one may want the cost of multiple matches to be high, when different multiplicities signify different functionality (e.g., the number of CPUs in a computer). In that case, the “edit distance” may prefer to “delete” a CPU when moving from one set to the other, rather than match one CPU to two CPUs in the other set. In addition, the cost of a match may account for similarity of the attributes of nodes that are matched to each other. For example, if one has two file systems, one of 10 Gbt and the second of 160 Gbt, arid the second has two file systems with 20 Gbt and 200 Gbt on may like them to be assigned in that order, so that the cost of their dissimilarity would be minimal.

To find an optimal set of matches, one may construct a weighted bi-partite graph, where the weights are the cost for the match for distance between the two CIs). In order to allow “delete” and “insert” operation two special nodes may be added (one for each set): a “delete” and an “insert” nodes. Nodes may be assigned to more than one node, but may be subjected to a certain penalty, according to their type. There is a verity of approaches to solve the weighted matching problem.

The matching problem may be solved, for example, using a minimal flow problem often known as “successive shortest path”. In essence, the successive shortest path algorithm solves the minimum cost flow problem as a sequence of shortest path problems with arbitrary link weights. To enforce the requirement that any node in each of the set is to have at least one node assigned to it in the other set, one may use a multi-excess formulation. Each node in the first set may have excess value of 1 and each node in the second set may have excess value of (−1). Moreover, the edges between the two sets may have capacity value, of 1 so that only pairs of nodes can be matched. Thus, each node may be required to be matched to at least one node in the other set (or to an insert/delete node). In order to allow many-to-one and one-to-many matches, one may add a source and a sink nodes that have a large excess, and add the cost of multiple matches on edges between the source and sink nodes and the nodes of the bipartite graph.

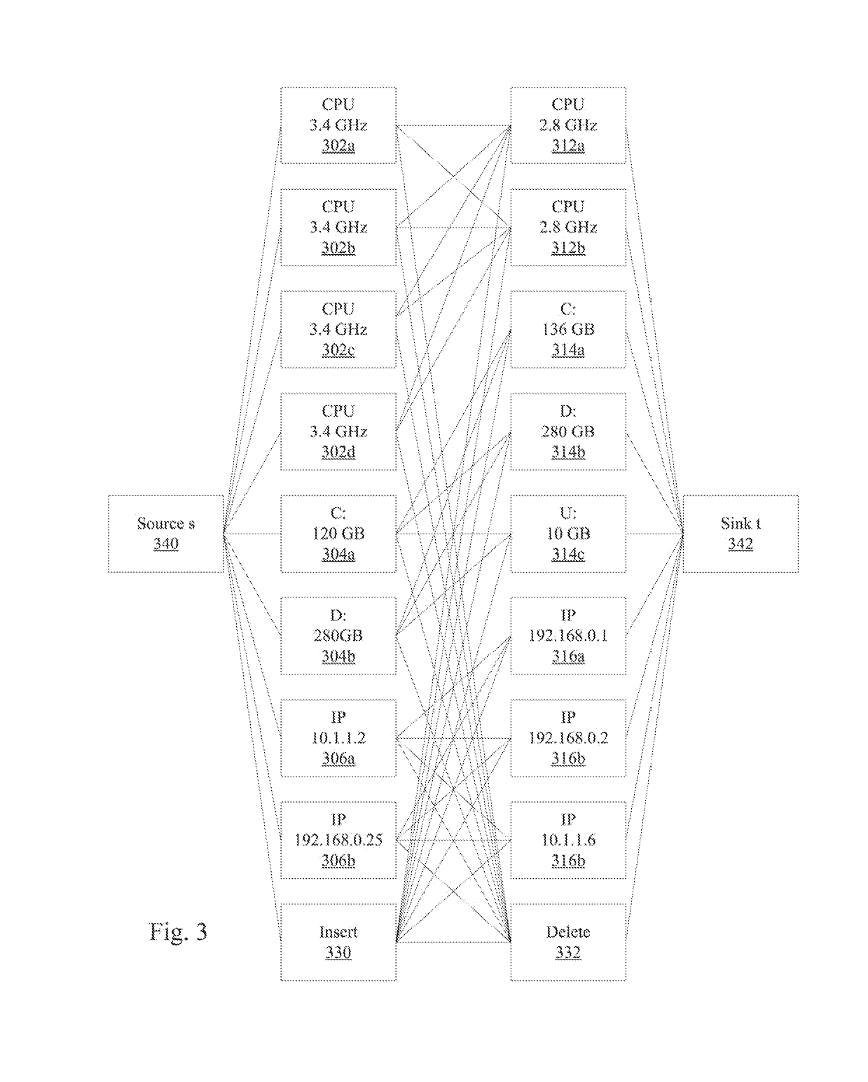

FIG. 3 illustrates a set up of a multiple-assignment problem of matching between nodes in composite CIs, by solving a minimal flow problem (successive shortest path) using a bi-partite graph, according to embodiments of the present invention.

In this figure two groups of CIs are compared and the minimal distance between them is calculated. One group of CIs includes four CPUs (302a, 302b, 302c, 302d), each operable at 3.4 GHz, two storing drives, C: with a storing capacity of 120 GB (304a), and D: with a storing capacity of 280 GB (304b), and two IP addresses (306a, 300b). The other group of CIs includes two CPUs operable at 2.8 GHz (213a, 312b), three storing drives. C: with a storing capacity of 136 GB (314a) and D: with a storing capacity of 280 GB (314b), and U: with a storing capacity of 10 GB (314c), and three IP addresses (316a, 316b, 316c),

Formally, given the two sets of children CIs \ddot{c}₁ and \ddot{c}₂, the assignment maps each cᵢ[i] to zero or more elements of \ddot{c}₂; similarly, zero or more elements of \ddot{c}₁ may be mapped to each c₂[j]. There is a cost d(c₁[i], c₂[j]) of assigning c₁[i] to c₂[j]. This cost corresponds to the dissimilarity between the CIs. There is a penalty, P, for assigning any CI to zero elements. In addition, there is a penalty P_{type} for multiple assignments to an element of type type. This penalty is accumulated for every assigned element except the first one. To match the elements of \vec{c}₁ with elements of \vec{c}₂, one may generate the following labeled graph G(V,E,Cost,Cap,Exc), where Cost and Cap are the cost and capacity labels for each edge, and Exc is an excess value assigned to each node. Recalling that the input is Params (see hereinabove) which includes \vec{P} that gives as penalty to each type of simple CI if assigned with multiplicity. Let P>1 be some constant penalty. The set of nodes and their excess are defined by V={s, t, del, insg} ∪ V₁ ∪ V₂ where the first 4 nodes are special nodes (source s 340, sink t 342, delete 332 and insert 330) and for each i ∈ {1, 2}, Vᵢ={eᵢ[i], . . . , cᵢ[ni]}. The excess parameters may include:

Exc(s)=|V₁|+|V₂|,

Exc(t)=−2|V₁|,

Exc(del)=Exc(ins)=0,

for each v ∈ V₁, Exc(v)=1,

for each v ∈ V₂, Exc(v)=−1,

The set of edges and their cost and capacity labels may be defined as follows:

For each v ∈ Vⱼ, e=(s, v)2 ∈, Cost(e)=P_{type}, and Cap(e)=∞, where type=type(₁[j]=v),

for each v ∈ V₂, e=(v, t) ∈ E, Cost(e)=P_{type}, and Cap(e)=∞, where type=type(c₂[j]=v),

for each v ∈ V₁, e=(v, del) ∈ E, Cost(e)=P, and Cap(e)=1,

for each v ∈ V₂, e=(ins, v) ∈ E, Cost(e)=P, and Cap(e)=1,

e=(s, ins) ∈ E, Cost(e)=0, and Cap(e)=∞,

e=(del, t) ∈ E, Cost(e)=0, and Cap(e)=∞,

for each v ∈ V₁ and u ∈ V₂, e=(v, u) ∈ E, Cost(e)=MD(c₁[j]=v, c₂[k]=u), and Cap(e)=1, which corresponds to the dissimilarity between the two CIs.

Denote by Reduce the procedure described above, of reducing the assignment problem to a multiple-assignment minimum-cost-flow problem, by creating the input graph G, and denote by MinCostFlow the minimum-cost-flow algorithm itself with the minimal cost as output, one may perform the following algorithm:

| | |
|---|---|
| Algorithm: MinCost(M_{D,} c_{1,} c_{2,} params) | (3) |
| G ← Reduce(M _{D}, c₁, c₂, params) | |
| return (MinCostFlow(G)) | |

In the example shown in FIG. 3 there are presented two hosts with CPUs, file systems and IP addresses as their children CIs. Thus there exist:

Set of N₁=9 elements c₁={CPU0, CPU1, CPU2, CPU3, C:, D:, E:, IP1, IP2}

Set of N₂=10 elements c₂={CPU0, CPU1, C:, D:, E:, N:, U:, IP1, IP2, IP3}; with number of elements

For each i and j the cost function is d(e₁[i], c₂[j]) and the capacity is 1. Note that for i and j so that type(c₁[i])≠type(c₂[j]) then d(c₁[i], c₂[j])=∞ and thus no edge is placed in the graph.

The capacity of all other edges is ∞.

An insert/delete penalty is enforced by a cost of P on any edge from/to these special nodes.

A penalty for multiple assignments is enforced in having cost of P_{type} on the edge to the source s or sink t. E.g. Cost(s, CPU0)=P_{CPU}. As CPU0 has excess 1, only a flow of 1 can originate from this node. Any other flow that will connect it to a node in the other set will have to flow from s and pay the penalty on multiplicity.

The cost 0 on the (insert, delete) edge enables us to drain the excess from s, when more than one node is assigned to any node.

It is noted that the successive shortest path typically has a pseudo-polynomial complexity. Yet, in the present case one may augment one unit of flow at every iteration, which would amount to assigning one additional pair of nodes. Consequently, if one lets N denote the number of CIs, the algorithm would terminate within N iterations and require polynomial running time.

In practice it is noted that many of the children CIs may be identical in all their values. In such a case, one may combine all the identical twins into one big node. In that case one may update the excess of this new node to be of absolute value that is equal to the number of siblings that this big node represents. It is evident that this may be equivalent to a solution with separate nodes. This may significantly improve the performance of the algorithm on real data.

A method of computing the cost functions, defined hereinabove, is now considered. The preprocessing step gathers statistics from the input Configuration Item data. This stage may be performed off-line and on a larger data set than the set to be later worked on. One may assume that there are CIs of various types (e.g., host, CPU, etc.). Let {type₁, type₂, . . . typeₜ} be the set of all types in the dataset and A₁, . . . , Aₜ be the set of all possible attributes. During the pre-process stage two sets of parameters are inferred:

Attribute weights. Attribute weights may be set for each CI type. Attribute weights may be used to ignore some non-relevant attributes, and may enable more informative attributes to influence the distance. For example, if almost all CIs agree on a single value, or alternatively almost each CI has a different value for a certain attribute, it cannot distinguish between similar and non-similar CIs. This insight may lead to the understanding that it would be useful to assign high weights to attributes with moderate entropy values. Thus, statistics may be gathered for each attribute attrᵢ counting the different values that appear in the data. For example, e.g. Windows-7: 245, Windows-Vista: 101, Unix: 7, etc.). Finally, for each i ∈[τ], j ∈[t] one may output wᵢⱼ, which may heuristically be computed as follows (this is given as an example):

If almost all (e,g, more than 90%) of the CIs of type typeᵢ have the same value for attrⱼ then wᵢⱼ=0.

If the CIs of type typeᵢ have many different values for attrᵢ (e.g. number of values is more than 10% of appearances) then wᵢⱼ=0.

One may assign negative and positive additional domain knowledge into the system, e.g., attributes of certain types can get always value 0 (e.g., dates or IP addresses or special attributes, such as ‘Name’, may obtain high value (say 10).

For all other attributes wᵢⱼ=1.

For each type, weights are normalized to sum up to 1.

CIs of different types are assumed to have an infinite distance. Alternatively, attribute weights may be used by the algorithm. In practice, one way combine this statistical approach with some domain knowledge in order to produce the weights.

Repetition penalty. A repetition penalty may be set for each CI type. The main idea is to look at the number of as of a certain type that tend to appear together in a composite CI. If that number varies greatly, e.g., consider IP addresses assigned to a server, then the penalty for repetition could be small. If on the other hand, that number is small, e.g., consider the number of CPUs in a server, then the penalty for repetition could be large. Thus, one may collect statistics about repetition count for each CI type, and compute the variance of the distribution of the repetition counts. The repetition penalty may influence the cost for making multiple assignments, which in turn will tend to make CIs with different repetition types more distant in other words—more dissimilar), especially if the repetition penalty is high, for example, a host with 1 CPU compared to a host with 4 CPUs.

A preprocessing algorithm may look as follows:

| | |
|---|---|
| Algorithm: Preprocess(\vec{C}I) | (4) |
| \vec{W} ← SetAttributeWeights(\vec{C}I) | |
| \vec{P}← GeneratePenaltyValues(\vec{C}I) | |
| return (\vec{W}, \vec{P}) | |

The algorithm SetAttributeWeights may be deduced straightforward from the description hereinabove. The algorithm for the penalty representation may be as follows:

```
Algorithm: GeneragePenaltyValues (\vec{C}I)
Hist[1,...τ] ← Ø, where Histᵢ = (Histᵢ¹, Histᵢ²)
for each CI ε \vec{C}I, for each v ε T(CI)
for each i ε [τ]
  do hᵢ = |{u ε children(v)|u is of type typeᵢ}|
if hᵢ ε Histᵢ¹
    then replace (hᵢ, k) ε Histᵢ with (Hᵢ, K+1)
      else add (Hᵢ, 1) to Histᵢ
for each i
      do P_{i←} 1/(1 + Variance(Hi\vec{s}tᵢ))
return (\vec{P})
```

Like other data-mining applications, it may be desired that a suitable clustering algorithm be efficient in both time and space. For such applications, agglomerative hierarchical clustering may typically be selected. This approach to clustering begins with every object as a separate cluster and repeatedly merges clusters. One may use a mode finding clustering approach that has good space and time performance because it uses neighbor lists, rather than a complete distance matrix. Neighbor lists may be determined based on a distance threshold θ. The running time and memory requirement for the algorithm is O(N×average (|η₀ⁱ|), where N is the number of objects to cluster and η₀ⁱ is the neighbor list of objectᵢ. One would normally expect the neighbor lists to be small and independent of N.

Algorithms for creating a policy given a set of composite CIs may now be considered. The input CIs can be assumed to adhere to some policy. At this point, a further assumption can he made that the CI clustering algorithm provides the frequent pattern clusters. Two algorithms may be invoked to generate a baseline policy. The first algorithm, ComputerPatternGraph, computes pattern inclusions and gathers statistics about the frequency and repetition of the patterns. As shown in Algorithm (5) (see below), graph GP is created, which is a hierarchical graph of the various clusters. Each duster is represented by a node in the graph. A duster node is linked as a parent of another cluster node if there exists a composite CI that is member of the first cluster which is a parent of a CI which is member of the second cluster. The edges are labeled by ranges. As each node may have many children that are member of the same cluster, these occurrences are counted, and the minimal and maximal such multiplicities per-edge are tracked.

| | |
|---|---|
| Algorithm: ComputePatternGraph(S, \vec{C}I) | (5) |
| G_{P}(V, E, L)← Ø | |
| for each S ε S add vₛ to V | |
| for each S,S′ ε S | |
| for each CI ε S | |
| N_{S,S′} ← \|{CI′ ε children(CI) : CI′ ε S′}\| | |
| for each S,S′ ε S : L(vₛ, v_{s′}) ← (∞,0) | |
| for each S,S′ ε S : if N_{S,S′} > 0 | |
| then add (v_{S}, v_{S′}) to E | |
| if N_{S,S′} < L₁(v_{S}, v_{Ss′}) : L₁(vₛ, v_{s′}) ← N_{S,S′} | |
| if N_{S,S′} > L₂(v_{S}, v_{Ss′}) : L₂(vₛ, v_{s′}) ← N_{S,S′} | |
| return G_{P} | |

Algorithm (5) works in time linear to the tree size. Hash tables may be used to calculate the minimum and maximum quantities of patterns. The next algorithm (Algorithm (6), see below), GeneratePolicy, utilizes a number of heuristics to build the policy from pattern paths in the pattern graph. The policy itself is actually at generalized CI in the sense that it is a tree of simple CIs with attributes. There are many ways to generate this tree out of the cluster graph GP. A very basic way is represented here, which seems advantageous in terms of performance. Generally speaking, it adds part of the graph GP in a greedy manner, as long as the support of the policy still exceeds the threshold which is given as input. An efficient function Match is assumed to exist which allows checking whether a CI matches a policy. At first the policy Pol is an empty graph so any CI would answer Match positively.

| | |
|---|---|
| Algorithm: GeneratePolicy(G_{P}, \vec{C}I, α)) | (6) |
| G_{P}=G_{P}(V, E, L) | |
| n ← \|\vec{C}I\|,r ← root(G_{P}) | |
| for each leaf v ε V : Rᵥ ← r → v | |
| sort({Rᵥ}ᵥ) | |
| Pol(V_{P}, E_{P}, L_{P}) ← Ø | |
| for each R_{V}: | |
| if \|CIᵢ : Match(CIᵢ,Pol ∪ Rᵥ)\| > αn | |
| then Pol ← Pol ∪ Rᵥ | |
| for each e ε E : | |
| while \|CIᵢ : Match(CIᵢ,Pol ∪ Rᵥ)\| > αn | |
| for k ← L₁(e) to L₂(e) : L_{P}(e) ← k | |
| return (Pol). | |

The function Sort sorts the different paths based on a priority for each path based on the minimum quantity on each edge in the path (the multiplicity), the support of the path and the depth of the path.

The proposed solution was tested on real customer data for two rather different types of configurations, both of which are quite common M practice.

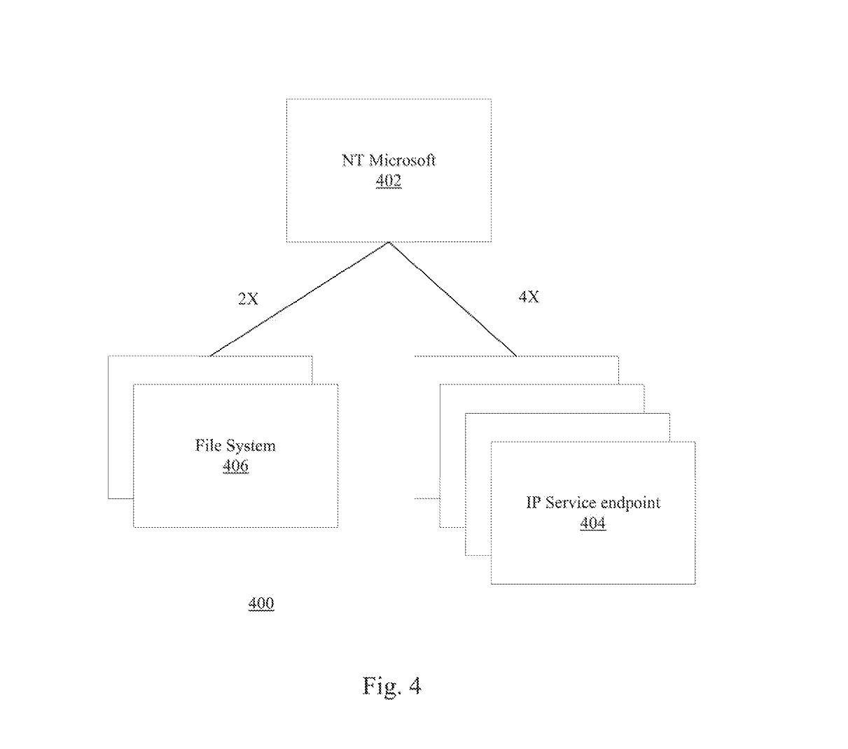

A first type of configuration involved a set of 700 hosts, which were compound CIs. In this dataset, each CIs had many children, but the depth of the CI tree was small. FIG. 4 depicts a simple policy rule 400 that was extracted from a large database in accordance with embodiments of the present invention. A policy extraction algorithm in accordance with embodiments of the present invention first clustered different type of hosts. In this example, for one cluster of NT hosts, the policy dictates that the NT machine should have a Microsoft OS 402, at least two file systems 406 and four IP service endpoints 404.

A second type of configuration involved a set of 8 CI J2EE domain CIs. In this data, each compound CI included thousands of CIs, and a complex tree structure. FIG. 2 depicts a policy extracted for this set, in accordance with embodiments of the present invention. This policy prescribes that each j2eedomain contains 22 jdbcdatasources (204), 3 j2eeapplications of one type (206) and one of a different type (207), in this example the two types of j2eeapplications differ by the CIs they contain. One type includes 3 different types of ejbmodule whereas the second type contains only one.

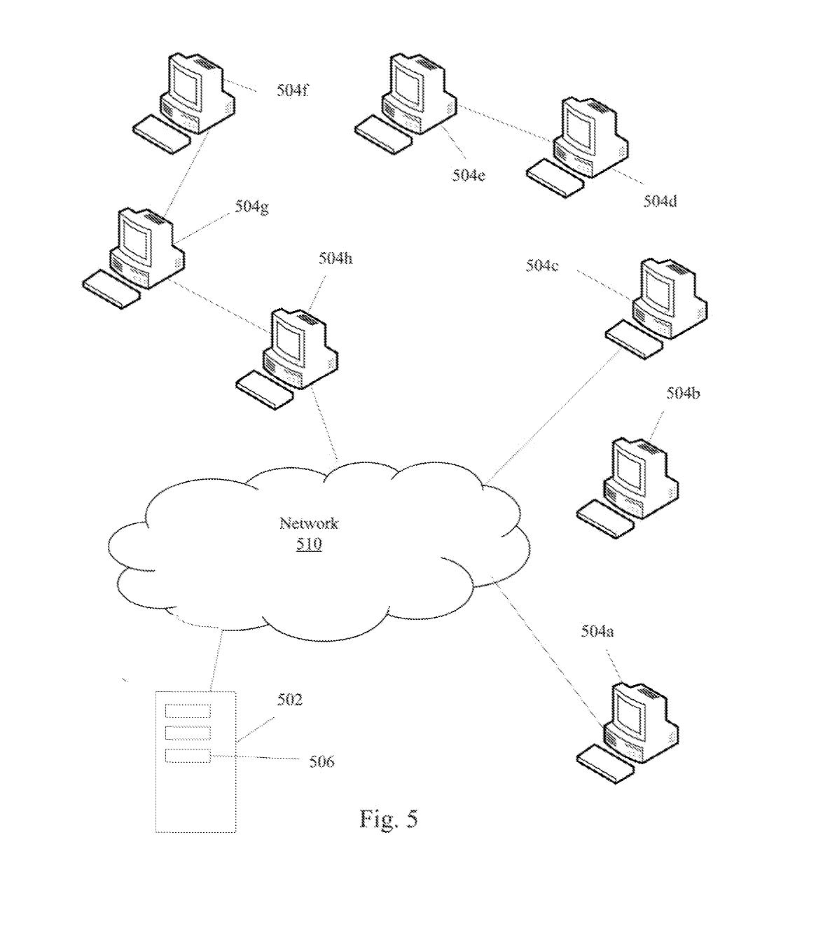

FIG. 5 illustrates a system for configuration policy extraction, in accordance with embodiments of the present invention.

An organization may have under its disposal various composite CIs (504a-g). For example, there may be CIs (504a, 504c) connected over a network 510 to configuration policy extractor device 502, there may also be, for example, composite. CIs (504d-e, 504f-g) connected b a local network, either connected to (504f-h) or separated from (504d-e) network 510. Additional CIs may include stand-alone composite CI (504e),

Configuration policy extractor device 502 may be provided in the form of a server or a host, and may include a configuration policy extraction module 506, which is designed to execute a method for configuration policy extraction, in accordance with embodiments of the present invention.

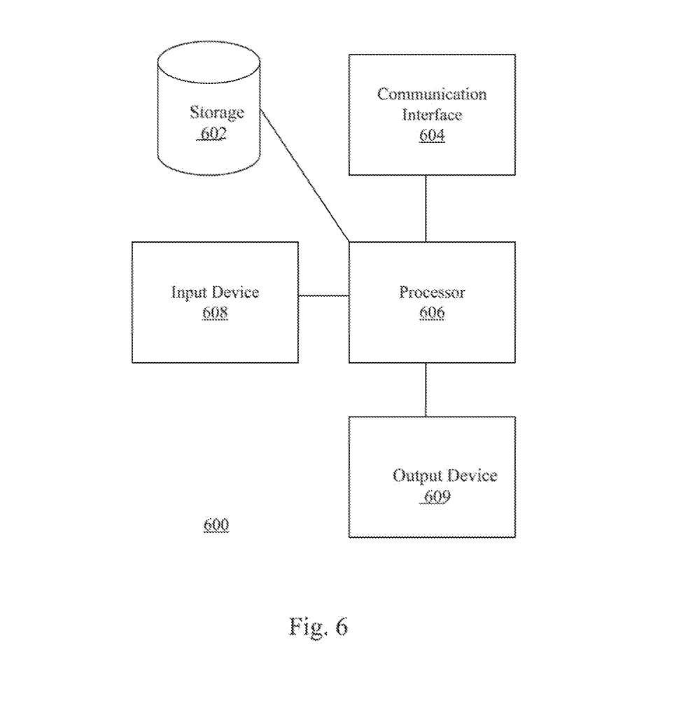

FIG. 6 illustrates a configuration policy extractor device 600, in accordance with some embodiments of the present invention. Such a device may include a non-transitory storage device 602, such as for example a hard-disk drive, for storing configuration data and executable programs for configuration policy extraction, in accordance with embodiments of the present invention, that may be executed on processor 606, an input device 608, such as, for example, keyboard, pointing device, electronic pen, touch screen and the like, may be provided to facilitate input of information or commands by a user. Communication interface 604 may be provided to allow communications between the configuration policy extractor device and an external device. Such communications may be point-to-point communication, wireless communication, communication over a network or other types of communications, facilitating input or output of information to or from the device. Output device 609 may also be provided, for outputting information from the device. e.g. a monitor, printer or other output device.

The storage device 602 may be used for storing, configuration data such as, for example, a Configuration Management Data Base (CMDB). According to some embodiments of the present invention, system 600 may include a crawler application that constantly, periodically or otherwise, searches an organization network to determine the configuration status of its composite CIs.

Embodiments of the present invention may include apparatuses for performing the operations described herein. Such apparatuses may he specially constructed for the desired purposes, or may comprise computers or processors selectively activated or reconfigured by as computer program stored in the computers. Such computer programs may be stored in a transitory or non-transitory computer-readable or processor-readable storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Embodiments, of the invention may include an article such as a computer or processor readable storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Features of various embodiments discussed herein may be used with other embodiments discussed herein. The foregoing description of the embodiments of the invention has been presented for the purposes of illustration and description. It is not intended to he exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is

1. A method for configuration policy extraction for an organization having a plurality of composite configuration items, the method comprising:
calculating distances in a configuration space between the composite configuration items:
clustering the composite configuration items into one or more clusters based on the calculated distances;
identifying configuration patterns in one or more of said one or more clusters; and
extracting at least one configuration policy based on the identified configuration patterns.

2. The method of claim 1, further comprising collecting configuration data on the composite configuration items of the organization.

3. The method of claim 1, wherein calculating the distances between the composite configuration items comprises determining similarity between trees, using a tree edit distance algorithm.

4. The method of claim 3, wherein calculating the distances between the composite configuration items is done by recursively solving a minimal flow problem.

5. The method of claim 4, wherein the minimal flow problem is used for matching between nodes of composite configuration items of the plurality of composite configuration items.

6. The method of claim 5, further comprising assigning weights to attributes of the composite configuration items.

7. The method of claim 5, further comprising assigning a repetition penalty, the penalty depending on attributes of the composite configuration items.

8. A non-transitory computer readable medium having stored thereron instructions for configuration policy extraction, which when executed by a processor cause the processor to perform the method of:
calculating distances in a configuration space between the composite configuration items:
clustering the composite configuration items into one or more clusters based on the calculated distances;
identifying configuration patterns in one or more of said one or more clusters; and extracting at least one configuration policy based on the identified configuration patterns.

9. The non-transitory computer readable medium of claim 8, including instructions to cause further the processor to perform the method collecting configuration data on the composite configuration items of the organization.

10. The non-transitory computer readable medium of claim 8, wherein calculating the distances between the composite configuration items comprises determining, similarity between trees, using a tree edit distance algorithm.

11. The non-transitory computer readable medium of claim 10, wherein calculating the, distances between the composite configuration items is done by recursively solving a minimal flow problem.

12. The non-transitory computer readable medium of claim 11, wherein the minimal flow problem is used for matching between nodes of composite configuration items of the plurality of composite configuration items.

13. The non-transitory computer readable medium of claim 12, including instructions to cause the processor to perform the method of assigning weights to attributes of the composite configuration items.

14. The non-transitory computer readable medium of claim 12, including instructions to cause the processor to perform the method of assigning a repetition penalty, the penalty depending on attributes of the composite configuration items.

15. A system for configuration policy extraction for configuration policy extraction for an organization having a plurality of composite configuration items, the system comprising a processor configured to:
calculate distances in a configuration space between the composite configuration items;
cluster the composite configuration items into one or more clusters based on the calculated distances:
identify configuration patterns in one or more of said one or more clusters; and
extract at least one configuration policy based on the identified configuration patterns.

16. The system of claim 15, comprising a storage device for storing configuration information

17. The system of claim 15, comprising a crawler application for automatically searching configuration data of the organization.

18. The system of claim 15, further comprising an input or output device.

19. The system of claim 15, comprising a communication module for communicating with one or more other devices.
